(19) United States
(12) Patent Application Publication
(10) Pub. No.: US 2023/0211577 A1
(43) Pub. Date: Jul. 6, 2023

(54) STRUCTURE HAVING VIBRATION ABSORPTION PROPERTY

(71) Applicants: HYUNDAI MOTOR COMPANY, Seoul (KR); KIA CORPORATION, Seoul (KR)

(72) Inventors: Sang Won Lim, Seoul (KR); Sang Beom Park, Yongin-si (KR); Sang Jae Yoon, Yongin-si (KR); ChiI Hoon Choi, Suwon-si (KR); Eol Han, Hwaseong-si (KR); In Sun Lee, Seoul (KR)

(73) Assignees: HYUNDAI MOTOR COMPANY, Seoul (KR); KIA CORPORATION, Seoul (KR)

(21) Appl. No.: 18/076,917

(22) Filed: Dec. 7, 2022

(30) Foreign Application Priority Data
Jan. 6, 2022 (KR) 10-2022-0002169

(51) Int. Cl. B32B 5/02; B32B 3/10; B32B 7/03; B32B 5/10; B32B 5/12

(52) U.S. Cl. CPC B32B 5/024; B32B 3/10; B32B 7/03; B32B 5/10; B32B 5/12; B32B 2262/106; B32B 2262/148; B32B 2305/08

(57) ABSTRACT

Proposed is a composite material with a helical structure and, more particularly, a composite material with a helical structure that has a vibration absorption property. The composite material includes a laminated structure formed by stacking a plurality of sheet layers on top of each other. The structural structure has a helical structure in which two adjacent sheet layers are slid with respect thereto with a predetermined angle being made therebetween in a stacking direction, and the predetermined angle α is less than 45°

### CROSS REFERENCE TO RELATED APPLICATION

This application claims priority to Korean Patent Application No. 10-2022-0002169, filed Jan. 6, 2022, the entire contents of which are incorporated herein by reference.

### FIELD

The present disclosure relates to a composite material with a helical structure and, more particularly, to a composite material with a helical structure that has a vibration absorption property.

### BACKGROUND

The statements in this section merely provide background information related to the present disclosure and may not constitute prior art.

A Quasi-Isotropic stacking method is a fundamental stacking method for Fiber-Reinforced Plastic (FRP) that minimizes later deformation and reflects a global isotropic property.

A stacking method in the related art is a method of sequentially arranging symmetrical structures. The stacking method uses a composite stacking sequence, such as [0/±45/90]s or [0/±30/±60/90]s.

However, a composite material manufactured using a Quasi-Isotropic stacking method in the related art, when used in a grinding wheel, is exposed to vibration for a long time. Thus, the component lifetime can be easily shortened.

The foregoing is intended merely to aid in the understanding of the background of the present disclosure, and is not intended to mean that the present disclosure falls within the purview of the related art that is already known to those having ordinary skill in the art.

### SUMMARY OF THE PRESENT DISCLOSURE

The present disclosure provides a composite material capable of having a more improved vibration property than a composite material manufactured using a Quasi-Isotropic stacking method.

The present disclosure is not limited to the above-mentioned objective. Other objectives of the present disclosure would be more apparent from the following description. The objective of the present disclosure can be realized by limitations set forth in claims and a combination thereof.

According to an aspect of the present disclosure, there is provided a composite material with a helical structure.

The composite material includes a laminated structure including the sheet layers of a plurality of sheet layers stacked on top of each other.

In one embodiment, each sheet layer of the plurality of sheet layers is disposed as rotated relative to an adjacent sheet layer thereof by a predetermined angle “α”, which is greater than 0° and less than 45°, thereby forming, overall, the helical structure.

In the composite material, the sheet layer may include fiber-reinforced plastic (FRP), carbon fiber-reinforced plastic (CFRP), or a combination thereof.

In the composite material, each sheet layer of the plurality of sheet layers may be made of a mixture of woven fiber and unidirectional (UD) fiber.

In the composite material, the sheet layers of the plurality of sheet layers may be stacked, in parallel, on top of each other.

In the composite material, one side of a respective sheet layer of the plurality of sheet layers and one side, corresponding thereto, of an adjacent sheet layer form an angle α greater than 0° and less than 45° therebetween.

In the composite material, the predetermined angle α between the two adjacent sheet layers may be in a range of 5° to 30°.

In the composite material, a stiffness of the composite material is in a range of 50 GPa to 57 PGa.

In the composite material, a strength of the composite material is in a range of 486 MPa to 504 MPa.

The composite material with a helical structure has a laminated structure formed by stacking sheet layers of a plurality of sheet layers on top of each other, in which respective adjacent sheet layers are slid or rotated with respect thereto with a predetermined angle being made therebetween in a stacking direction. Thus, the composite material with a helical structure can improve a vibration property more than a composite material manufactured using a Quasi-Isotropic stacking method.

In addition, the composite material with a helical structure is formed in such a manner as to have a Semi-Spiral-Helix structure. Thus, the composite material can retain existing physical properties thereof, improve a vibration property, a breakage property, a deformation property, and dimensional stability, and reduce a microstructural defect.

The present disclosure is not limited to the above-mentioned advantageous effect. Advantageous effects of the present disclosure should include all advantageous effects deducible from the following description.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is an upper side view schematically illustrating a composite material according to one embodiment of the present disclosure, when viewed from above;

FIGS. 2A and 2B are photographs each showing a result of an experiment with a fracture behavior of Comparative Example;

FIGS. 3A and 3B are photographs each showing a result of an experiment with a fracture behavior of Implementation Example;

FIG. 4A is a photograph showing a result of an experiment with dimensional stability of Comparative Example;

FIG. 4B is a photograph showing a result of an experiment with dimensional stability of Implementation Example;

FIG. 5A is a photograph showing a result of deformation evaluation of Comparative Example;

FIG. 5B is a photograph showing a result of deformation evaluation of Implementation Example;

FIGS. 6A, 6B, and 6C are photographs each showing a result of defect and orientation evaluation of Comparative Example;

FIGS. 7A and 7B are photographs each showing a result of defect and orientation evaluation of Implementation Example; and

FIG. 8 is a photograph showing that the composite material according to one embodiment of the present disclosure is applied to grinding wheels.

### DETAILED DESCRIPTION

The above-mentioned objectives, other objectives, features, and advantages of the present disclosure would be easily understood from embodiments that are described below with reference to the accompanying drawings. However, the present disclosure is not limited to the embodiments described below and may be practiced in other forms. A description of the embodiments in sufficient detail is provided to contain adequate enabling disclosure and to enable a person of ordinary skill in the art to get a full understanding of the technical idea of the present disclosure.

It should be understood that in the present application, the term “include”, “have”, or the like is intended to indicate that a feature, a number, a step, an operation, a constituent element, a component, or a combination of these, which is described in the present specification, is present. Therefore, the term does not negate that one or more other features, numbers, steps, operations, constituent elements, components, or combinations of these may be present and added. In addition, a component, such as a layer, a film, a region, or a plate, when expressed as being on the “top” of another component, is meant to be vertically on another component, and, when expressed as being “over” or “above” another component, may be meant to be “over” or “above” another component with a third component in between. In addition, a component, such as a layer, a film, a region, or a plate, when expressed as being “underneath” another component, is meant to be vertically “underneath” another component, and, when expressed as being “under” or “below” another component, may be meant to be “under” or “below” another component with a third component in between.

When a component, device, element, or the like of the present disclosure is described as having a purpose or performing an operation, function, or the like, the component, device, or element should be considered herein as being “configured to” meet that purpose or to perform that operation or function.

The present disclosure relates to a composite material with a helical structure that has a vibration absorption property. A configuration of the composite material is described in detail below.

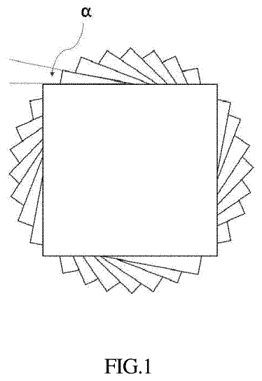

The composite material with a helical structure according to one embodiment of the present disclosure is described below with reference to FIG. 1. FIG. 1 is a cross-sectional view schematically illustrating the composite material.

With reference to FIG. 1, the composite material has a laminated structure that results from stacking sheet layers of a plurality of sheet layers on top of each other. The laminated structure has a helical structure in which two adjacent sheet layers are slid with respect thereto with a predetermined angle “a” being made therebetween in a stacking direction. In one embodiment, the predetermined angle α is less than 45°.

The sheet layer may include fiber-reinforced plastic (FRP), carbon fiber-reinforced plastic (CFRP), or a combination thereof.

The fiber-reinforced plastic may include plastic reinforced with polymer fibers.

The sheet layers may be successively stacked, upward from the bottom surface of the structure, on top of each other with one sheet layer being slid at the predetermined angle α with respect to another. In one embodiment, the sheet layers may be successively stacked, upward from the bottom surface of the structure, on top of each other in such a manner that two adjacent sheet layers are kept slid in the same direction with respect thereto.

The sheet layers are parallelly stacked on top of each other. The sheet layer may be formed of a mixture of woven fiber and unidirectional (UD) fiber.

The use of the mixture of woven fiber and UD fiber as a material of the sheet layer may improve dimensional stability of the composite material resulting from stacking the sheet layers on top of each other.

The laminated structure results from sequentially stacking the sheet layers on top of each other in a Quasi-Isotropic arrangement manner.

In the laminated structure, the predetermined angle α that one side of one of the two adjacent sheet layers makes with respect to one side of the other thereof is greater than 0° and less than 45°. Specifically, in the laminated structure, the predetermined angle α between the two adjacent sheet layers may be in a range of 5° to 30°.

The laminated structure has a helical structure in which the sheet layers are stacked on top of each other with one sheet layer being slid at the predetermined angle α with respect to another. Thus, the composite material having this helical structure can have more improved vibration properties than a composite material in the related art that results from stacking the sheet layers in a Quasi-Isotropic manner.

Specifically, the helical structure of the laminated structure is a structure that results from symmetrically stacking the sheet layers on top of each other in a Semi-Helix arrangement manner, namely, a Semi-Spiral-Helix structure.

The composite material with a helical structure according to the present disclosure may have a stiffness in a range of 50 GPa to 57 GPa and a strength in a range of 486 MPa to 504 MPa.

In addition, assuming that the composite material with a helical structure, in the upright position, is divided into an upper half and a lower half, sheet layers in the upper half and sheet layers in the lower half may be the same in the stress and curvature that occur due to in-plane/out-of-plane stiffness factors.

The composite material with a helical structure according to the present disclosure may have a structure that varies when the predetermined angle α, the number Ply of sheet layers, a symmetrical or asymmetrical arrangement, or a sheet-layer material is changed.

In order to verify advantageous effects of the present disclosure, evaluation of specific embodiments thereof was conducted as follows. The embodiments are described below only to assist in getting an understanding of the present disclosure, and the scope of the present disclosure is not limited thereto.

<Physical Property Evaluation>

In order to evaluate mechanical physical properties of the composite material, samples of composite material according to Comparative Examples 1 to 5 and Implementation Examples 1 and 2 were manufactured using a stacking method and a material for stacking that are shown in following Table 1. Physical properties of the manufactured samples of the composite material were evaluated using a Universal Testing Machine (UTM).

Regarding the notation for expressing a stacking angle for the composite material and expressing a repeating pattern therefor, it should be hereinafter noted that the stacking angle is read in the direction from left to right and that stacking is performed in the direction from the bottom surface to the top surface. In addition, the suffix “s” refers to symmetrical restacking as is the case with a composite stacking sequence: +45/−45/0/90/90/0/−45/+45. By contrast with the suffix “s”, the suffix “ns” refers to asymmetrical restacking as is the case with a composite stacking sequences: +45/−45/0/90/+45/−45/0/90.

TABLE 1

| | | | | | | Unit/Price |
|---|---|---|---|---|---|---|
| | | Stiffness | Strength | Material | Physical | (Single |
| | Stacking | [GPa] | [MPa] | (Type) | Property | Product) |
| Comparative | S45C | 210 | 400 | Steel | Isotropic | 100 |
| Example 1 | | | (Yield) | | | (Reference) |
| Comparative | Cross-Ply(0/90)s | 55 | 650 | Woven | Anisotropic | 200 |
| Example 2 | | | | | | |
| Comparative | Cross-Ply[(0/90)/0/90]s | 64 | 794 | Woven + | Anisotropic | 150 |
| Example 3 | | | | UD | | |
| Comparative | 45° Quasi-Isotropic[(0/90)/(±45)]s | 42 | 505 | Woven | Quasi- | 200 |
| Example 4 | | | | | Isotropic | |
| Comparative | 20° Quasi-Isotropic[(0/90)/0/±20/. . ./±80/(±45)]s | 44 | 547 | Woven + | Anisotropic | 120 |
| Example 5 | | | | UD | | |
| Implementation | 30° Semi-Helix[(0/90)/30/60/. . ./180/(0/90)]s | 50 | 486 | Woven + | Quasi- | 120 |
| Example 1 | | | | UD | Isotropic | |
| Implementation | 30° Semi-Helix (Except for Woven Fabric of | 57 | 504 | Woven + | Quasi- | 120 |
| Example 2 | which a Center Portion is Formed) | | | UD | Isotropic | |
| | [(0/90)/30/60/. . ./180]s | | | | | |

From Table 1, it can be seen that Implementation Examples 1 and 2, manufactured using a 30-degree Semi-Helix method and a mixture of woven fiber and UD fiber, have a more excellent strength of 400 MPa or higher than Comparative Example 1 manufactured using a S45C stacking method and a steel material.

In addition, it can be seen that Implementation Examples 1 and 2 have physical properties at the same level as Comparative Examples 4 and 5 manufactured using a Quasi-Isotropic stacking method in the related art.

### Fracture Behavior Evaluation

It was checked whether or not a fracture behavior of a sample is due to a gradual breakage or an abrupt/catastrophic breakage resulting from fiber breakage.

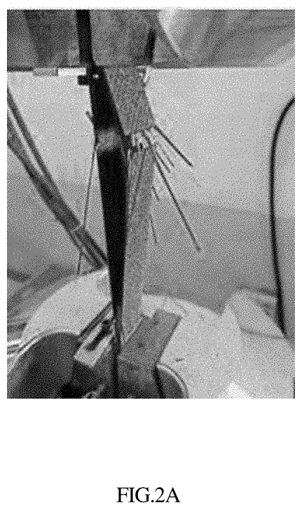

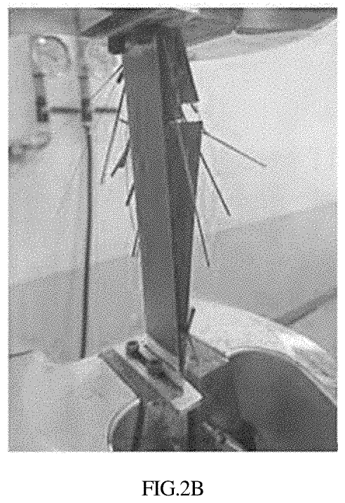

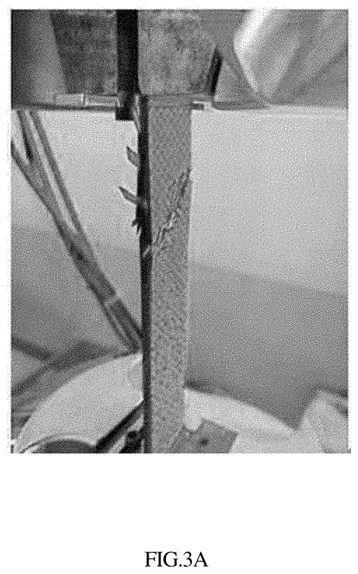

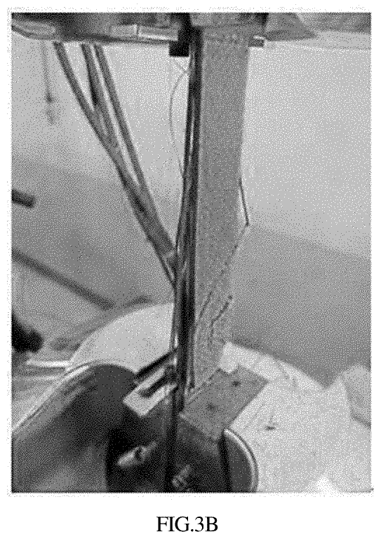

Results of the evaluation of the fracture behavior of the sample are described with reference to FIGS. 2A, 2B, 3A, and 3B. FIGS. 2A and 2B are photographs each showing a result of an experiment with a fracture behavior of Comparative Example. FIGS. 3A and 3B are photographs each showing a result of an experiment with a fracture behavior of Implementation Example.

With reference to FIGS. 2A and 2B, a phenomenon where a local region of a sample was broken because of breakage of stacked US fiber due to tensile stress occurred to a sample manufactured using a 45-degree Quasi-Isotropic stacking method.

By contrast, with reference to FIGS. 3A and 3B, because of gradual breakage of a sample due to inter-layer shearing stress, a global breakage occurred to a sample manufactured using the 30-degree Semi-Helix stacking method.

Therefore, it can be seen that the composite material manufactured using the Semi-Helix stacking method is effective in preventing an abrupt breakage.

### Dimensional Stability Evaluation

Through photographing using a DIC image correlation method, it was checked whether or not stress concentrates on a local region of a sample, depending on whether or not fabric is used.

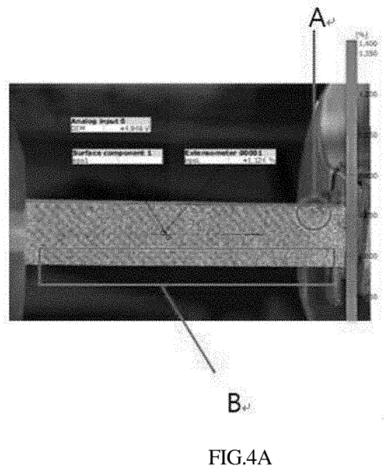

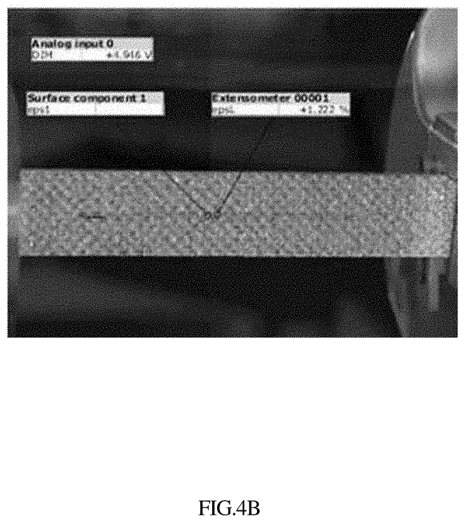

Results of dimensional stability evaluation of a sample is described with reference to FIGS. 4A and 4B. FIG. 4A is a photograph showing a result of an experiment with dimensional stability of Comparative Example. FIG. 4B is a photograph showing a result of an experiment with dimensional stability of Implementation Example.

From FIG. 4A, it can be seen that, in a case where, using the 30-degree Semi-Helix stacking method, a sample was manufactured without the center of the sample being reinforced with a nonwoven product, due to concentration of stress on an internal local region of the sample, breakage occurred as in portion A and cracks occurred in an edge portion as in portion B.

By contrast, from FIG. 4B, it can be seen that, in a case where, using the 30-degree Semi-Helix stacking method, a sample was manufactured with the center of the sample being reinforced with the nonwoven product, the sample was normally broken without concentration of stress on the inside of the sample.

Therefore, the use of the fabric can prevent concentration of stress on a local region of the composite material that results from stacking using the Semi-Helix stacking method.

### Deformation Evaluation

Deformation evaluation was made by forming plate-shaped samples of the composite material according to Implementation Example and Comparative Example.

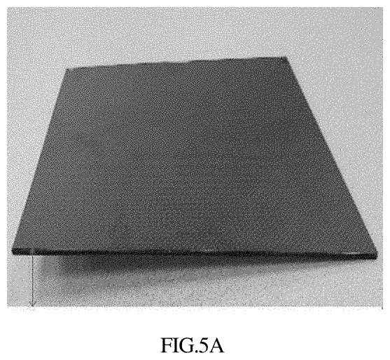

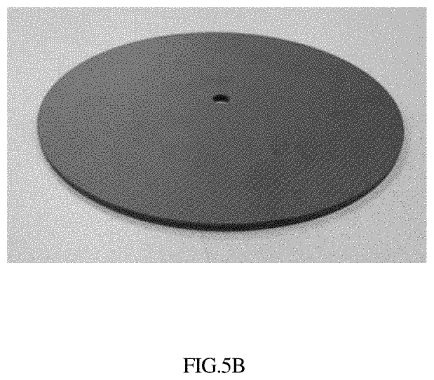

Results of the deformation valuation of the sample are described with reference to FIGS. 5A and 5B. FIG. 5A is a photograph showing a result of deformation evaluation of Comparative Example. FIG. 5B is a photograph showing a result of deformation evaluation of Implementation Example.

The number of sheet layers Ply of the composite material illustrated in FIG. 5A that is manufactured using a Full-Helix 20-degree stacking method is 61, and the thickness thereof is 18T. The composite material was in a state of being deformed without being flat.

By contrast, the number of sheet layers Ply of the composite material illustrated in FIG. 5B that is manufactured using a Semi-Helix 30-degree stacking method is 62, and the thickness thereof is 18T. The composite material was in a state of being flat without being deformed.

According to the present disclosure, before a sample is formed, ABD Matrix stiffness factors can be predicted using the Classical Laminate Theory (CLT). Thus, deformation can be predicted by checking whether or not a factor of a B matrix in an ABD Matrix is zero (0). For example, in a case where a B Matrix stiffness factor is not zero (0), later deformation can be predicted. Thus, Spiral-Helix stacking can be recomputed using symmetry and coupling effects. Therefore, with the result of the prediction using the CLT, the composite material according to the present disclosure can be prevented from being deformed.

### Defect and Orientation Evaluation

In order to verify an internal defect and orientation of the composite material manufactured in a Spiral-Helix stacking manner, CT scan was performed on the sample manufactured for the deformation evaluation, and then a pore and misalignment/undulation were evaluated.

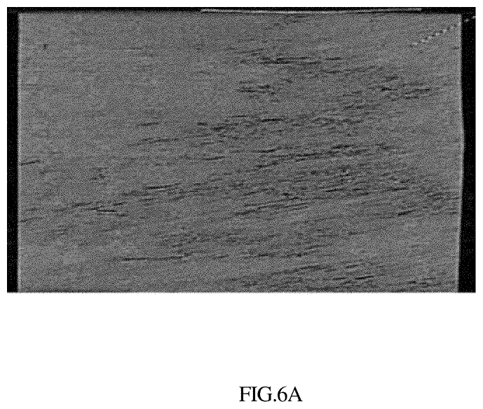

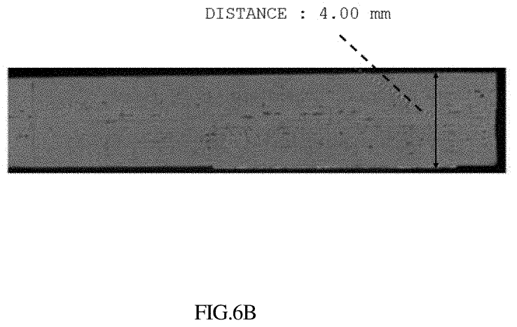

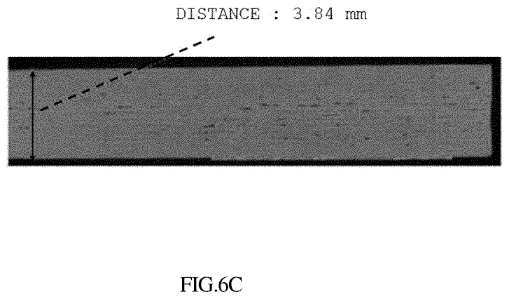

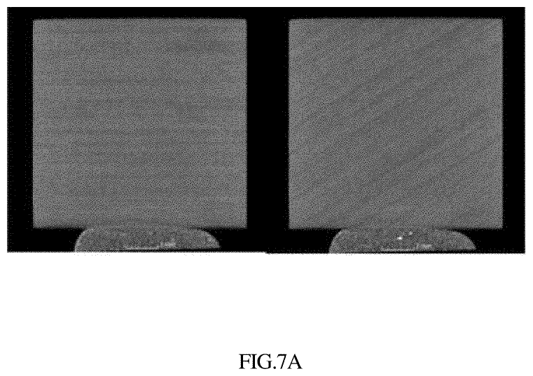

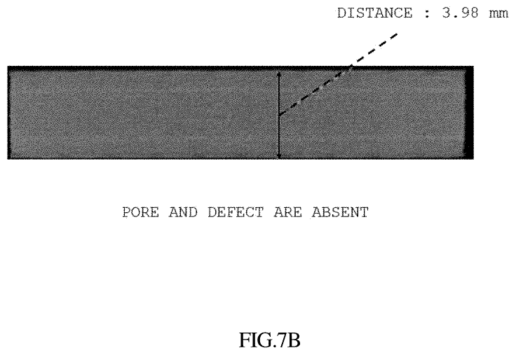

Results of defect and orientation evaluation of the sample are described with reference to FIGS. 6A, 6B, 6C, 7A, and 7B. FIGS. 6A, 6B, and 6C are photographs each showing a result of defect and orientation evaluation of Comparative Example. FIGS. 7A and 7B are photographs each showing a result of defect and orientation evaluation of Implementation Example.

From FIG. 6A, it can be seen that the pore and the defect appeared inside the composite material according to Comparative Example appeared. In addition, from FIGS. 6A and 6B, it could be seen that opposite sides of the composite material according to Comparative Example had different dimensions.

By contrast, from FIG. 7A, it can be seen that the pore and the defect did not occur inside the composite material according to Implementation Example. In addition, from FIG. 7B, it can be seen that the composite material was uniformly manufactured without any dimensional deviation on opposite sides thereof.

Therefore, it can be seen that the composite material according to the present disclosure is effective in reducing the defect inside the sample and reducing the dimensional deviation due to the later deformation.

### Vibration Property Evaluation

For vibration evaluation, a circular sample was securely held in a Free-Free state and then was evaluated for vibration thereof. Vibration evaluation items are the number of unique vibrations and the number of vibration modes. Modeling for the same form was performed, and in this case, correct conditions for physical properties and restraints that were applied to a sample for evaluation were assigned to and were verified.

Results of the vibration evaluation showed that the composite material according to the present disclosure that was manufactured using the Semi-Helix stacking method had more excellent vibration properties than the composite material manufactured using a steel and a Quasi-Isotropic stacking method.

Accordingly, the composite material with a helical structure according to the present disclosure can minimize later deformation thereof and retain the isotropic properties. Furthermore, the composite material can be improved in terms of vibration properties and durability, and a behavior of continuous fiber-reinforced plastic can be mitigated.

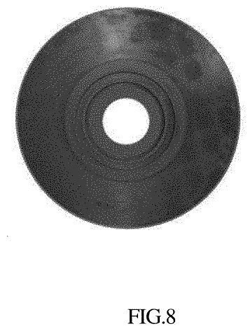

As illustrated in FIG. 8, the composite material according to the present disclosure may be applied to grinding wheels. FIG. 8 is a photograph showing that the composite material application in the grinding wheels according to the present disclosure.

Accordingly, the composite material with a helical structure according to the present disclosure that finds application in the grinding wheel has a longer lifetime and a higher recycling rate than a steel in the related art that is used as a tool exposed to vibration for a long time. Thus, the cost-saving effect can be expected.

In addition, the composite material with a helical structure may be applied to a rotary body as one embodiment of the present disclosure such that when the rotary body having such a helical stacking structure is exposed to vibration for a long time, stability and performance in terms of roughness and fatigue can be maximized. Thus, the lifetime of the composite material can be lengthened.

The embodiments of the present disclosure are described above, and it should be apparent to a person of ordinary skill in the art to which the present disclosure pertains that the present disclosure can be practiced in other specific forms without any modification to the technical idea and the feature thereof. Therefore, in every aspect, the embodiments described above should be understood as being exemplary and non-restrictive.

What is claimed is:

1. A composite material with a helical structure, the composite material comprising:
a laminated structure comprising a plurality of sheet layers stacked on top of each other,
wherein each sheet layer of the plurality of sheet layers is disposed as rotated relative to an adjacent sheet layer thereof by a predetermined angle α, which is greater than zero degrees (°) less than 45 degrees (°), thereby forming the helical structure.

2. The composite material of claim 1, wherein each sheet layer of the plurality of sheet layers comprises fiber-reinforced plastic (FRP), carbon fiber-reinforced plastic (CFRP), or a combination thereof.

3. The composite material of claim 1, wherein each sheet layer of the plurality of sheet layers comprises a mixture of woven fiber and unidirectional (UD) fiber.

4. The composite material of claim 1, wherein the sheet layers of plurality of sheet layers are stacked, in parallel, on top of each other.

5. The composite material of claim 1, wherein, one side of each sheet layer of the plurality of sheet layers and one side, corresponding thereto, of an adjacent sheet layer forms an angle α greater than 0° and less than 45° therebetween.

6. The composite material of claim 1, wherein the predetermined angle α is in a range of 5° to 30°.

7. The composite material of claim 1, wherein a stiffness of the composite material is in a range of 50 GPa to 57 PGa.

8. The composite material of claim 1, wherein a strength of the composite material is in a range of 486 MPa to 504 MPa.
